(19) United States
(12) Patent Application Publication
(10) Pub. No.: US 2013/0299293 A1
(43) Pub. Date: Nov. 14, 2013

(54) HUB ASSEMBLY HAVING RECONFIGURABLE ROTATIONAL MODES

(71) Applicant: EBIUS TRADING & DISTRIBUTING, Cary, NC (US)

(72) Inventor: Michael Bruce Corley, China Grove, NC (US)

(73) Assignee: EBIUS Trading & Distributing, Cary, NC (US)

(21) Appl. No.: 13/887,991

(22) Filed: May 6, 2013

(30) Foreign Application Priority Data
May 8, 2012 (TW) M440895
Oct. 25, 2012 (CN) 201220549568.5

(51) Int. Cl. F16D 41/26

(52) U.S. Cl. CPC F16D 41/26
USPC 192/32

(57) ABSTRACT

A rotational assembly hub can include a sprocket that is configured to rotate about an axis, where the sprocket can be located on a first side of a driver. Moveable paws can be located on a second side of the driver that is opposite the first side of the driver. The moveable paws can be configured to move from a recessed position within the driver to a protruding position when the driver rotates in a first direction in a first rotational mode and can be configured to remain protruding from the recessed position when rotated in the first direction in a second rotational mode. Other assemblies are also disclosed.

### CROSS-REFERENCE TO RELATED APPLICATIONS

This U.S. non-provisional patent application claims priority under 35 U.S.C. §119 of Taiwanese Patent Application No. M440895, filed on May 8, 2012, and of Chinese Patent Application 201220549568.5 filed on Oct. 25, 2012, the contents of all of which are hereby incorporated herein by reference in their entireties.

### FIELD

The present invention relates generally to the field of rotational assemblies and, more particularly, to hubs for rotational assemblies.

### BACKGROUND

FIG. 1 illustrates a known BMX/Freestyle bicycle configuration. The bicycle 10 includes a frame 11, back wheel 14, front wheel 14′, and driver system 15. The back wheel 14 and front wheel 14′ are mounted to the front and back of frame 11 via the front suspension cradle 12 and back suspension cradle 13, respectively. The driver system 15 includes pedals 16, a first sprocket 17, a chain 18, and a bicycle hub assembly 100. A rider can spin the first sprocket 17 by pushing the pedals 16 in a circular motion, which moves the chain 18.

The bicycle hub assembly 100 can rotate in response to movement of the chain 18, which can spin the back wheel 14 (and possibly the front wheel 14′) to move the bicycle 10 forward. Additionally, pegs 19 and pegs 19′ are coupled to the back wheel 14 and front wheel 14′, respectively, to enable the rider to perform stunts.

FIG. 2 is a more detailed illustration of the bicycle hub assembly 100. The bicycle hub assembly 100 includes an axle 110, a hub 120, a driver 130, an internal gear wheel 140, and a series of bearings 150. The hub 120 can be driven on the bearings 150 about the axle 110.

FIG. 3 shows a lateral view of the driver 130 and internal gear ring. The driver 130 includes a second sprocket 132 and a series of paws 134. The paws 134 are arranged around the driver 130 in a circular pattern.

FIG. 4 illustrates a body of the hub and internal gear wheel. The first right hand thread RHT 142 is on the outer surface of the internal gear wheel 140. The second RHT 122 is on the inside surface of the body of bicycle hub 120. The first and second RHT 142, 122 can be threaded clockwise together, which fixes the internal gear ring 140 inside the body of the bicycle hub 120.

According to FIGS. 3 and 4, the rotation of the driver causes the paws 134 to engage with the internal teeth 144 on the internal gear ring 140. This action spins the internal gear ring 140, causing the body of bicycle hub 120 to be driven which moves the bicycle 10 forward.

When the second sprocket 132 is rotated counterclockwise by the chain 18, the paw 134 of the driver 130 can slide past the internal teeth 144 of the internal gear ring, so that the body of the hub 120 is not driven (sometimes referred to as “idle running”). In “idle running”, when the paw 134 of the driver 130 slides past the internal teeth 144 on the internal gear ring, a “clicking” noise may occur which is commonly associated with convention hub assemblies.

Referring to FIG. 3, when the internal gear ring 140 spins clockwise, the internal teeth 144 of the internal gear ring 140 slides past the paw 134. When the back wheel 14 is “idle running” backward (meaning that the internal gear ring 140 also spins counter-clockwise) the internal teeth 144 of internal gear ring 140 engages with the paw 134, which spins the driver 130 backward (counterclockwise) causing the driver 130 to pull the chain 18 and drive the pedals backward (counterclockwise).

A Freecoaster bicycle hub is also discussed in, for example, Taiwanese Patent Publication Number TW-201113167.

### SUMMARY

Embodiments according to the present invention can provide rotational hub assemblies that are reconfigurable to have different rotational modes. Pursuant to these embodiments, a rotational assembly hub can include a sprocket that is configured to rotate about an axis, where the sprocket can be located on a first side of a driver. Moveable paws can be located on a second side of the driver that is opposite the first side of the driver. The moveable paws can be configured to move from a recessed position within the driver to a protruding position when the driver rotates in a first direction in a first rotational mode and can be configured to remain protruding from the recessed position when rotated in the first direction in a second rotational mode.

In some embodiments according to the invention, the driver includes troughs, where the hub can further include first removable springs in the troughs that can be configured to provide a first force on the moveable paws toward the recessed position. In some embodiments according to the invention, the troughs each include circular arc shaped sub-troughs located on opposing ends of the troughs. In some embodiments according to the invention, first portions of the first removable springs can be configured for insertion into the sub-troughs. In some embodiments according to the invention, the hub can further include second portions of the first removable springs, wherein the paws each include first and second opposing jaws linked together by a linkage surface that is recessed relative to outer surfaces of the first and second jaws and can be configured to engage with the second portions of the first removable springs.

In some embodiments according to the invention, the driver can include recesses, and the hub can further include second removable springs in the troughs that can be configured to provide a second force on the moveable paws toward the protruding position. In some embodiments according to the invention, the troughs can each include circular arc shaped sub-troughs located on opposing ends of the troughs. In some embodiments according to the invention, first portions of the second removable springs can be configured for insertion into the sub-troughs.

In some embodiments according to the invention, the hub can further include second portions of the second removable springs that can be configured to engage with bottom surfaces of the paws. In some embodiments according to the invention, the hub can further include a clutch that can include a first side thereof facing the first side of the driver to selectively engage with the moveable paws in the first rotational mode. In some embodiments according to the invention, the clutch can include a second side thereof that is opposite the first side of the driver, where the second side can be configured to face the first side of the driver in the second rotational mode, that can be configured to remain spaced apart from the first side of the driver in the second rotational mode.

In some embodiments according to the invention, the hub can further include a spring configured for placement to surround the axis of rotation and to force the clutch to contact the first side of the driver. In some embodiments according to the invention, the hub can be a BMX style bicycle wheel hub. In some embodiments according to the invention, the first rotational mode can be a Freecoaster configuration rotational mode and the second rotational mode can be a Cassette configuration rotational mode. In some embodiments according to the invention, a surface of the paws that faces away from the sprocket is substantially planar and is free on a protrusion. In some embodiments according to the invention,

[symbol]

In some embodiments according to the invention, a BMX bicycle hub can include a rider re-configurable driver including a sprocket configured to rotate about a BMX bicycle axle, the rider re-configurable driver configured to provide a Freecoaster configuration rotational mode in a first configuration and provide a Cassette configuration rotational mode in a second configuration.

In some embodiments according to the invention, a rotational hub assembly can include a driver including a sprocket that can be configured to rotate about an axis of the driver rotation and can include spaced-apart troughs in an outer circumferential surface of the driver and separate springs that can be configured for insertion into each of the spaced-apart troughs in the outer circumferential surface of the driver.

### BRIEF DESCRIPTION OF THE DRAWINGS

FIG. 1 is an illustration of a BMX freestyle bicycle according to the prior art.

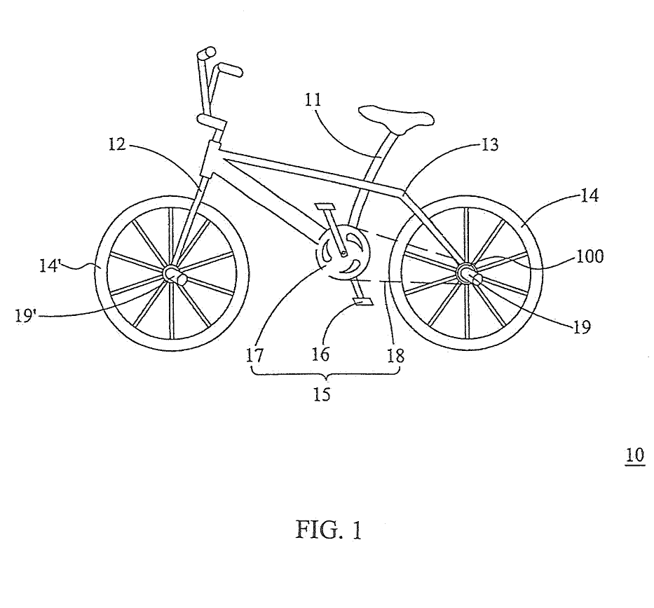

FIG. 2 is a detailed cross-sectional view of the bicycle hub shown in the FIG. 1.

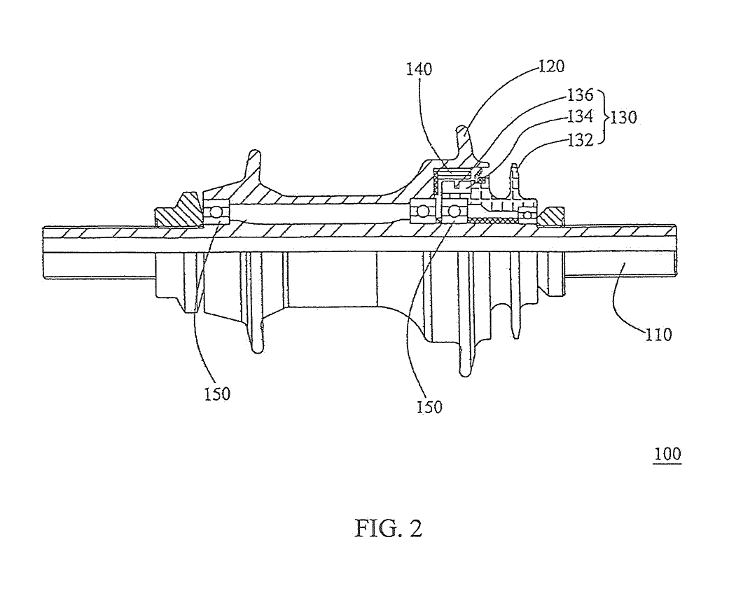

FIG. 3 is side view of the ratchet wheel and the internal gear ring shown in FIG. 2.

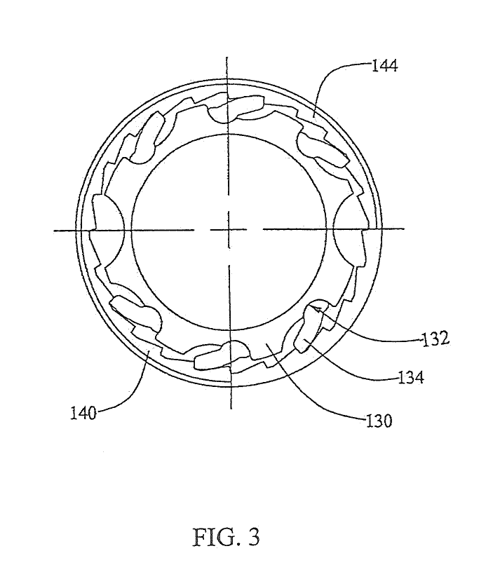

FIG. 4 is perspective view of the bicycle hub and the internal gear ring shown in FIG. 2.

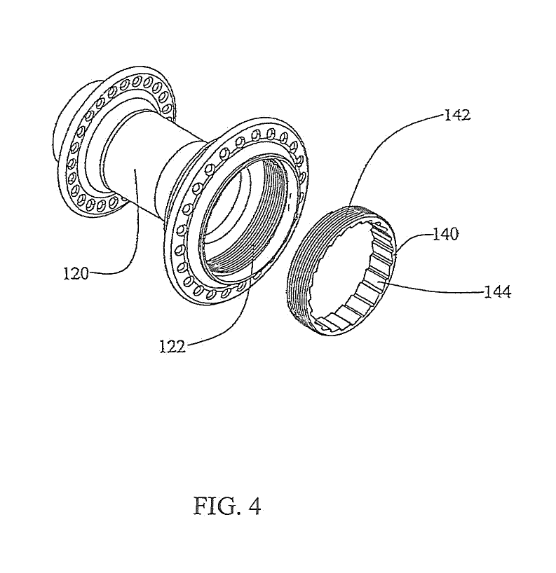

FIG. 5 is an exploded view of a hub in some embodiments according to the present invention.

FIG. 6A is a side view of a ratchet wheel in some embodiments according to the present invention.

FIG. 6B is a perspective view of a paw in some embodiments according to the present invention.

FIG. 7 is a side view of a clutch in some embodiments according to the present invention.

FIG. 8 is a side view of the ratchet wheel actuated by the clutch in the Freecoaster configuration mode of rotation in some embodiments according to the present invention.

FIG. 9 is a side view of the ratchet wheel in the Cassette configuration mode of rotation in some embodiments according to the present invention.

### DETAILED DESCRIPTION OF EMBODIMENTS

In some embodiments according to the invention, a hub assembly (such as a hub assembly for a BMX style bicycle) can be configured in a “cassette mode” or in a “Freecoaster mode.” In the cassette mode, the hub allow a wheel to be mechanically engaged by paws when the wheel moves in both forward and reverse directions so that, for example, when the wheel rotates backwards, the pedals also rotate backwards. In the Freecoaster mode, however, the hub allows the wheel to be mechanically engaged by paws only when the wheel moves in the forward direction, whereas the wheel is not mechanically engaged by the paws when the wheel moves in the reverse direction. Accordingly, when the wheel rotates backwards in Freecoaster mode, for example, the pedals do not rotate backwards.

In some embodiments according to the invention, a bicycle hub assembly includes an axle, a driver, an internal gear wheel, a hub, clutch and a second elastic spring. The driver is disposed around the axle wherein the driver includes at least one sprocket, a series of troughs, a series of paws and a series of first springs. The sprocket is located on one side of the driver and the trough is located on the opposite side of the driver relative to the sprocket. The trough can have a first sub-trough and a second sub-trough. The paw has a first end and a second end. The first spring has a first end and a second end. The internal gear ring surrounds the paws and a series of teeth (sometimes referred to as gears) on then internal surface of the internal gear ring. A hub is disposed around the axle. The clutch has an axial hole and a cam. The cam has multiple protruding parts. The second spring is disposed around the axle.

In some embodiments according to the invention, a bicycle hub assembly includes an axle, a driver, an internal gear wheel, a hub, a clutch and a second elastic spring. The driver is disposed around the axle, and the driver includes at least one sprocket, a trough, paws and first springs. The sprocket is placed at one side of the driver. The trough is placed at another side of the driver. The trough has a first sub-trough and a second sub-trough and both of the sub-troughs have circular arcs. The trough also includes a bottom surface between the first sub-trough and the second sub-trough. Moreover, the paw has a first end and a second end. The first end of the paw is placed inside the first sub-trough with the first spring, where the first spring has a first end and a second end. The first end of the first spring is placed inside the second sub-trough and the elasticity is provided to the paw by the second end of the first spring.

In some embodiments according to the present invention, internal teeth are included on the interior surface of the internal gear ring. The internal teeth are configured to mechanically engage with the second end of the paw. The hub is disposed around the axle, and the clutch includes an axle hole through which the axle passes. The clutch includes a cam having a plurality of blocks on the cam spaced apart around the circumference thereof to selectively engage with the paws. The second spring is disposed around the axle. The elasticity of the second spring can force the clutch against the paws.

In some embodiments according to the present invention, when the driver spins in a first direction relative to the clutch, the block of the cam will engage with the paws. This action makes the second end of the paw lift out of the trough to mechanically engage with the internal teeth, whereas when the driver spins in the second direction relative to the clutch, the block of the cam disengages from the paws, whereupon the elasticity of the first spring causes the paw to return to the trough. It will be understood that the first direction and the second directions can be opposite to one another.

In some embodiments according to the present invention, the first sub-trough and the second sub-trough are symmetrical to one another.

In some embodiments according to the present invention, the paw includes a first jaw, a second jaw, and a linkage surface linking the first and second jaws together. The linkage surface is configured to be engaged by the second end of the first spring to hold the paw in the trough. The paw will be moved away from the block of the cam of the clutch when the ratchet wheel spins through the second direction. This action makes the elasticity of the first spring force the paw into the trough toward the linkage surface.

In some embodiments according to the present invention, a collar is located around the axle between the clutch and the driver. In some embodiments according to the present invention, the collar includes metal.

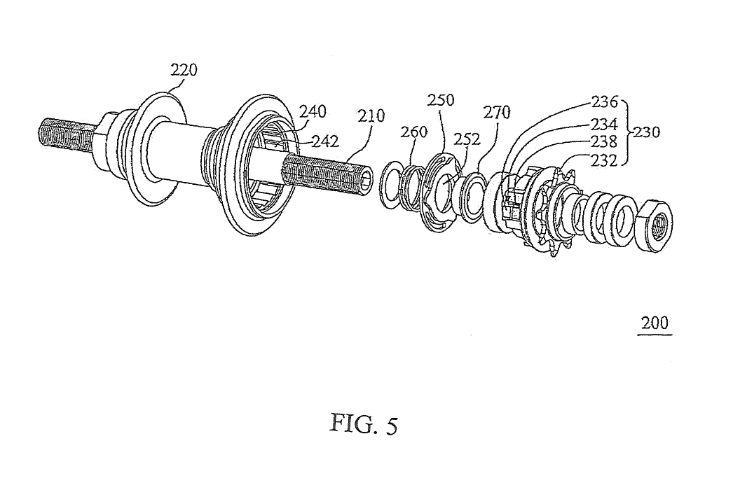

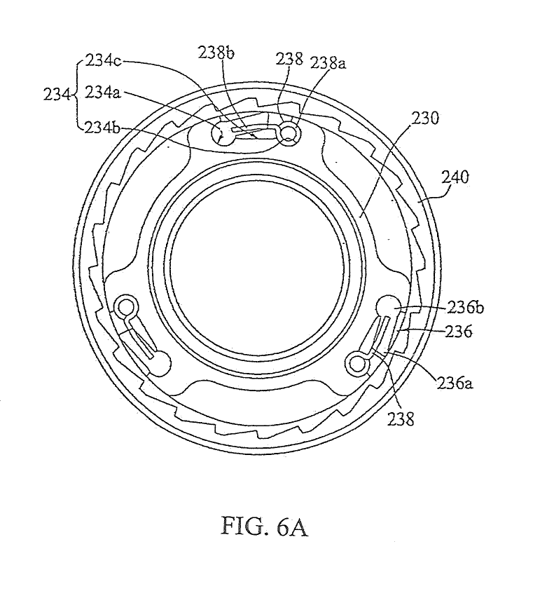

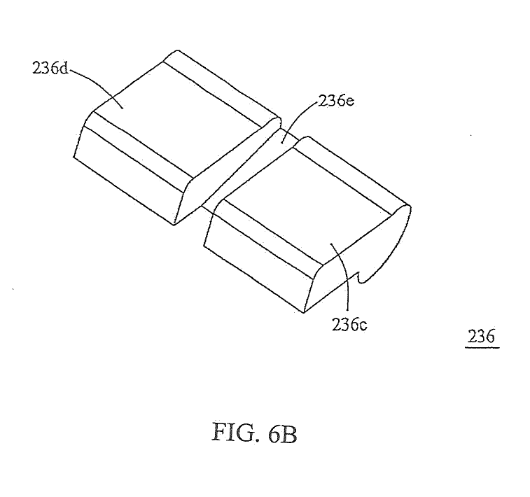

FIG. 5 is an exploded view of a hub in some embodiments according to the present invention. FIG. 6A is a side view of a ratchet wheel configured in Freecoaster configuration mode of rotation, in some embodiments according to the present invention. Referring to FIGS. 5 and 6A, in some embodiments according to the present invention, the hub 200 includes an axle 210, a hub 220, a driver 230, an internal gear ring 240, a clutch block 250, and a second spring 260. The hub 220 and the driver 230 are disposed around the axle 210. The driver 230 includes a sprocket 232, several troughs 234, paws 236, and first springs 238. The sprocket 232 is located on one side of the ratchet 230 and the troughs 234 are located on the other side of the sprocket 232 and each trough 234 includes first and second sub-troughs 234a, 234b, both of which may have a circular arc shape. The first and second troughs 234a and 234b can be symmetrical with each other and a bottom surface 234c links the first and second sub-troughs 234a.

In some embodiments according to the present invention, in the Freecoaster configuration mode of rotation, the paws 236 include a first end 236a and a second end 236b, where the both ends 236a and 236b can be recessed inside the first trough 234a so that at least any protrusion of the paws from the trough 234a is small enough to avoid the internal teeth from engaging with the internal gear ring 240 unless engaged by the cam and blocks. The first springs 238 include a first end 238a and a second end 238b, where the first end 238a of the first spring 238 is recessed inside the sub-trough 234b and the second end 238b of first spring 238 provides tension on the paw 236 to keep the paw 236 recessed within the trough 234. The internal gear ring 240 includes internal teeth 242 set on the internal surface of the internal gear ring 240. The internal teeth 242 are suitable for the second end 236b of the paw 236 to mechanically engage when the sprocket 232 rotates in the clockwise direction, for example.

FIG. 6B is a perspective view of a paw in some embodiments according to the present invention. In some embodiments according to the present invention, the paw 236 includes a first jaw 236c, a second jaw 236d and a linkage surface 236e. The linkage surface 236e links the first jaw 236c and the second jaw 238b together and defines a channel therebetween. The linkage surface 236e can be engaged by the second end 238b of the first spring 238 when the hub is configured in the Freecoaster configuration mode of rotation.

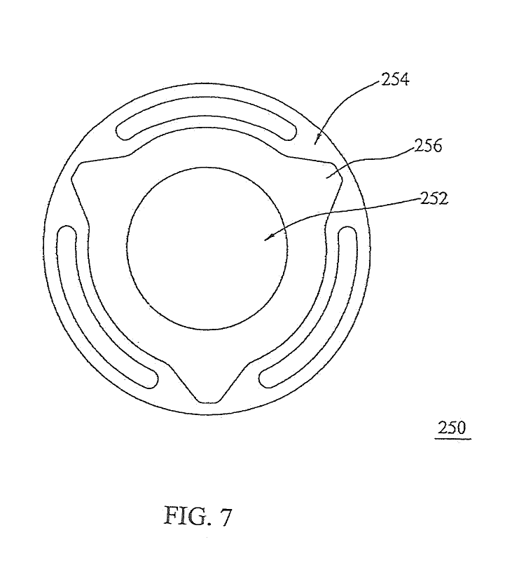

FIG. 7 is a side view of a clutch in some embodiments according to the present invention. According to FIG. 7, an axle hole 252 is included in the clutch 250, which is disposed around the axle by placing the axle through the axle hole 252. The clutch 250 includes a cam 254 and numerous blocks 256. In some embodiments according to the present invention, in the Freecoaster configuration mode of rotation the blocks 256 can engage with the paws 236 when the sprocket 232 rotates clockwise. The hub 200 includes a second spring 260 which is also disposed around the axle 210.

In some embodiments according to the present invention, one end of second spring 260 provides tension on the clutch 250 to press the clutch 250 against the ratchet wheel 230. In some embodiments according to the present invention, this action makes the clutch 250 fit closely together with the ratchet wheel 230. In some embodiments according to the present invention, the hub 200 includes a collar 270. In some embodiments according to the present invention, the collar 270 can be metal and can be placed in the axle hole 252 of the clutch 250 around the axle 210 in different orientations depending on whether the Freecoaster or Cassette configuration rotational mode is used.

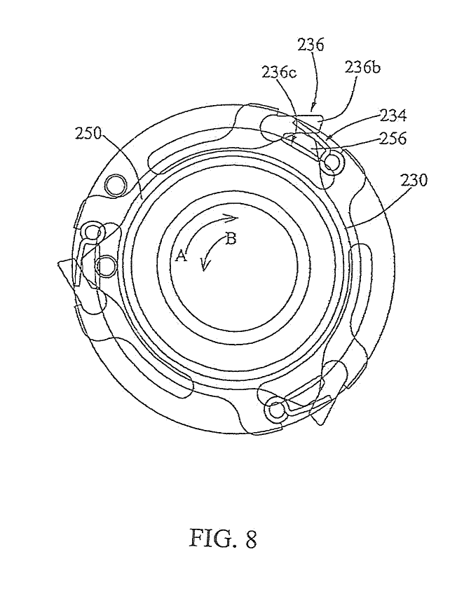

FIG. 8 is a side view of the ratchet wheel actuated by the clutch in the Freecoaster configuration rotational mode in some embodiments according to the present invention. In some embodiments according to the present invention, when the driver 230, which is relative to the clutch 250, spins in the first direction A, the block 256 of the cam 254 will engage with the paw 236 to lift the second end 236b of the paw 236 of the trough 234, as shown. When the driver 236, which is relative to the clutch 250, spins in the second direction B, however, the block 256 of the cam 254 will disengage from the paw 236, thereby allowing the second end 236b of the paws 236 to recess back into the trough due to the tension from the first spring 238 applied to the paws 236. When the paw 236 is recessed into the trough 234, the paw 236 fits together with the bottom surface 236c. It will be understood that the blocks 256 can face toward the paws 236 when the hub is in Freecoaster configuration rotational mode.

In some embodiments according to the present invention, in the Freecoaster configuration mode of rotation, when the second chain wheel 232 is spun by the chain 18 in the clockwise direction, the sprocket 230 will be engaged by the clutch 250 and spin in the first direction A. The block 256 of the cam 254 engages the paw 236 which makes the second end 236b of the paw 236 lift out the trough 234 and engage the internal teeth 242, causing the internal gear ring 240 to spin. When the internal gear ring 240 spins, the hub 220 will follow, thereby moving the bicycle forward.

In some embodiments according to the present invention, in the Freecoaster configuration mode of rotation, when second sprocket 232 is pulled by chain 18 to spin counter-clockwise, however, the driver 236 spins in the second direction B and the block 256 of the cam 254 disengages from the paw 236. In addition, the paw 236 may also disengage from the block 256 of the cam 254 when the wheel spins in a forward direction (assuming that the driver 230 is not spun in the counter-clockwise direction.

In either case, this action allows the paw 236 to be recessed back into the trough 236 (by the tension of first spring 238) to fit closely together with the surface of the bottom 236c. Because the paw 236 is recessed into the trough 234, it can avoid being engaged by the internal teeth 242 of the internal gear ring 240, such as when the bicycle moves backward, which can also avoid creating the “clicking” noise associated with backward movement of some wheels in the prior art.

As described herein, the hub 200 can be configured to be in the Freecoaster mode (described for example above in reference to FIGS. 6-8), wherein the hub allows the wheel to be mechanically engaged by paws when the wheel moves in only the forward direction. When the wheel rotates backwards in Freecoaster mode, the pedals do not rotate backwards. It will be understood, however, that when the hub is re-configured to be in the Cassette mode of rotation, the wheel is mechanically engaged by the paws so that the pedals do rotate backwards when the wheel moves backwards.

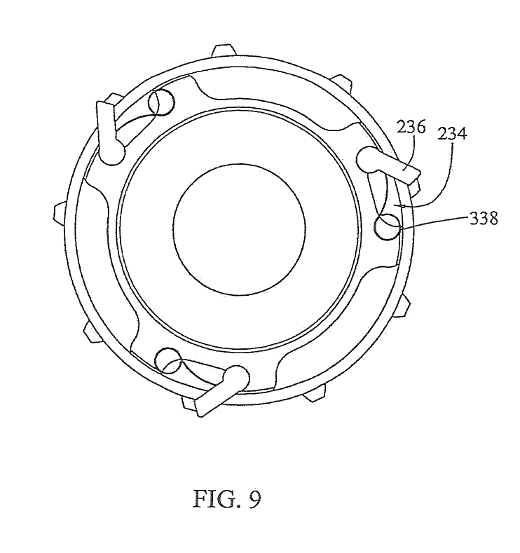

FIG. 9 is a side view of the ratchet wheel being reconfigured in the Cassette configuration mode of rotation in some embodiments according to the present invention. In particular, although the hub 200 may be configured to be in Freecoaster mode of rotation, the hub 200 can be re-configured to be in the Cassette mode by replacing the first spring 238 with a first spring 338. It will be understood that whereas the first spring 238 acts to keep the paw 236 recessed in the trough in the Freecoaster mode, in Cassette mode the first spring 338 in FIG. 9 lifts one end of the paw 236 out the trough 234 by the tension of the first spring 338. It will be understood that the blocks 256 can face away the paws 236 when the hub is in Cassette configuration rotational mode as shown, for example, in

[symbol]

Accordingly, the hub can be configured for Freecoaster mode or Cassette mode by swapping the particular springs used to engage with the paws. For example, the first springs can be used to hold the paws in the troughs (until engaged by the blocks) in Freecoaster mode, whereas the second springs can be used to force the paws to protrude from the troughs without engagement of the blocks.

Relative terms such as “below” or “above” or “clockwise” or “counterclockwise” may be used herein to describe a relationship of one element to another element as illustrated in the figures. It will be understood that these terms are intended to encompass different orientations of the assemblies in addition to the orientation depicted in the figures.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

What is claimed:

1. A rotational assembly hub comprising:
a sprocket configured to rotate about an axis, the sprocket located on a first side of a driver; and
moveable paws located on a second side of the driver opposite the first side of the driver, wherein the moveable paws are configured to move from a recessed position within the driver to a protruding position when the driver rotates in a first direction in a first rotational mode and the moveable paws are configured to remain protruding from the recessed position when rotated in the first direction in a second rotational mode.

2. The hub of claim 1 wherein the driver includes troughs, the hub further comprising:
first removable springs in the troughs configured to provide a first force on the moveable paws toward the recessed position.

3. The hub of claim 2 wherein the troughs each include circular arc shaped sub-troughs located on opposing ends of the troughs.

4. The hub of claim 3 wherein first portions of the first removable springs are configured for insertion into the sub-troughs.

5. The hub of claim 4 further comprising:
second portions of the first removable springs, wherein the paws each include first and second opposing jaws linked together by a linkage surface that is recessed relative to outer surfaces of the first and second jaws and configured to engage with the second portions of the first removable springs.

6. The hub of claim 1 wherein the driver includes recesses, the hub further comprising:
second removable springs in the troughs configured to provide a second force on the moveable paws toward the protruding position.

7. The hub of claim 6 wherein the troughs each include circular arc shaped sub-troughs located on opposing ends of the troughs.

8. The hub of claim 7 wherein first portions of the second removable springs are configured for insertion into the sub-troughs.

9. The hub of claim 8 further comprising:
second portions of the second removable springs configured to engage with bottom surfaces of the paws.

10. The hub of claim 1 further comprising:
a clutch including a first side thereof facing the first side of the driver to selectively engage with the moveable paws in the first rotational mode.

11. The hub of claim 10 wherein the clutch includes a second side thereof, opposite the first side of the driver, the second side being configured to face the first side of the driver in the second rotational mode, that is configured to remain spaced apart from the first side of the driver in the second rotational mode.

12. The hub of claim 10 further comprising:
a spring configured for placement to surround the axis of rotation and to force the clutch to contact the first side of the driver.

13. The hub of claim 1 wherein the hub comprises a BMX style bicycle wheel hub.

14. The hub of claim 13 wherein the first rotational mode comprises a Freecoaster configuration rotational mode and the second rotational mode comprises a Cassette configuration rotational mode.

15. The hub of claim 1 wherein a surface of the paws facing away from the sprocket is substantially planar and is free on a protrusion.

16. A BMX bicycle hub comprising:
a rider re-configurable driver including a sprocket configured to rotate about a BMX bicycle axle, the rider re-configurable driver configured to provide a Freecoaster configuration rotational mode in a first configuration and provide a Cassette configuration rotational mode in a second configuration.

17. The BMX bicycle hub of claim 16 wherein when in the first configuration, the sprocket remains idle when the BMX bicycle hub moves in a backwards direction.

18. The BMX bicycle hub of claim 17 wherein when in the second configuration, the sprocket rotates with the BMX bicycle hub moving in the backwards direction.

19. The BMX bicycle hub of claim 16 further comprising:
moveable paws located on the driver, wherein the moveable paws are configured to, in the first configuration, move to a recessed position within the driver when the BMX bicycle hub moves in a backward direction.

20. The BMX bicycle hub of claim 17 further comprising:
moveable paws located on the driver, wherein the moveable paws are configured to, in the second configuration, move to remain in a protruding position from the driver when the BMX bicycle hub moves forwards or backwards.

21. A rotational assembly hub comprising:
a driver including a sprocket configured to rotate about an axis of the driver rotation and including spaced-apart troughs in an outer circumferential surface of the driver; and
separate springs configured for insertion into each of the spaced-apart troughs in the outer circumferential surface of the driver.

22. The hub of claim 21 further comprising:
moveable paws configured for insertion into each of the spaced-apart troughs, wherein the separate springs are configured to engage with different portions of the paws based on a configuration rotational mode of the hub.

23. The hub of claim 22 wherein in a first configuration rotational mode the separate springs are configured in the spaced-apart troughs to contact upper surfaces of the moveable paws.

24. The hub of claim 23 wherein in a second configuration rotational mode the separate springs are configured in the spaced-apart troughs to contact lower surfaces of the moveable paws that are opposite the upper surfaces.

25. The hub of claim 21 wherein the spaced-apart troughs each include circular arc shaped sub-troughs located on opposing ends of the spaced-apart troughs.
